(19) United States
(12) Patent Application Publication
(10) Pub. No.: US 2019/0383681 A1
(43) Pub. Date: Dec. 19, 2019

(54) Driving Belt Tension Detection Device and Application Thereof

(71) Applicant: TAIOKU MANUFACTURING (JIANGSU) CO., LTD., Suzhou (CN)

(72) Inventor: Mingqiang Xu, Suzhou (CN)

(21) Appl. No.: 16/556,260

(22) Filed: Aug. 30, 2019

Related U.S. Application Data
(63) Continuation of application No. PCT/CN2017/090287, filed on Jun. 27, 2017.

(30) Foreign Application Priority Data
Mar. 1, 2017 (CN) 201710115166.1

(51) Int. Cl. G01L 5/10; F16H 7/10; B62M 9/16

(52) U.S. Cl. CPC G01L 5/10; B62M 9/16; F16H 7/10

(57) ABSTRACT

The present invention discloses a driving belt tension detection device, comprising a support (1), wherein one end of the support (1) in the length direction is rotatably connected with a connecting portion (2) for being mounted on a driving wheel, the other end of the support (1) in the length direction is slidely provided with a tension detection part (3) for clamping a driving a belt to measure the tension of the driving belt. The support (1) is also provided with a slide adjusting part (4) for adjusting a slide position of the tension detection part (3). If the detected tension of the driving belt does not meet the requirement, the distance between the driving wheel and a driven is adjusted to adjust the tension on the driving belt to be appropriate. The detection device has high detection accuracy and is less affected by noise.

### CROSS REFERENCE TO RELATED APPLICATIONS

This is a continuation of International Application No. PCT/CN2017/090287, filed on Jun. 27, 2017, which claims the priority benefits of Chinese Application No. 201710115166.1, filed on Mar. 1, 2017. The entirety of each of the above-mentioned patent applications is hereby incorporated by reference herein and made a part of this specification.

### TECHNICAL FIELD

The present disclosure relates to the field of measuring the tension of a rope, a cable, a wire, a belt or similar flexible elements, and in particular, to a driving belt tension detection device and application thereof.

### BACKGROUND

A driving belt is becoming the choice of transmission on many vehicles and mechanical equipments due to its characteristics in terms of good elasticity, absorbing shocking and vibrating loads, stable operation, noiseless, or the like. However, there are strict requirements on the degree of tightness of a driving belt in many application fields using a driving belt. For example, the tension of a driving belt on each bicycle leaving the factory which adopts belt driving has to be strictly detected, and the bicycle will be not qualified until the tension meets the requirements.

At present, a Chinese Patent Publication No. CN202350966U discloses an engine belt tension detection device, which comprises a detection probe and a detection body, the detection probe being connected to one end of the detection body via a pipeline, an acoustic sensor being provided within the detection probe, the detection body comprising a case and a tension detection device provided in the case, and a display and a keying area connected to the tension detection device being provided on the front face of the case.

Such a detection device obtained the tension of a belt by detecting the vibration frequency of the belt after being knocked via the detection probe followed by calculation. However, in spite of the ability of detecting the tension of a driving belt, when such a detection device is used for performing detection in a noisy workshop, large noises in the workshop will degrade the detection accuracy of the acoustic sensor, and thus have a great impact on the accuracy of the final measuring results. Therefore, there is still room for improving this detection device and the detection method thereof.

### BRIEF SUMMARY

Regarding the defects present in the prior art, a first object of the present invention is to provide a detection device of a driving belt tension having the advantage that the detection accuracy is less likely affected by environmental noise.

In order to achieve the above object, the present application provides the following technical solutions:

a driving belt tension detection device comprises a support, a connecting portion being rotatably connected at one end of the support in the length direction for being mounted on a drive wheel, a tension detecting portion being provided at the other end of the support and slidably movable along the length direction of the support, which is used for clamping the driving belt for measuring the value of the tension of the driving belt, and a sliding adjusting portion being provided on the support for adjusting the sliding position of the tension detecting portion.

By adopting the above technical solution, when detecting the tension of the driving belt, the connecting portion is firstly mounted on the drive wheel, the driving belt is then put in the tension detecting portion so that the tension detecting portion clamps the upper side and the lower side of the belt, that is, the upper side and the lower side of the driving belt press against the tension detecting portion and apply the tension of the belt directly onto the tension detecting portion, which thus can directly detect the value of the tension of the driving belt, being hardly effected by an environmental noise. During a real-time detection of the tension on the driving belt, if the detected tension on the driving belt is not qualified, the distance between the drive wheel and the driven wheel can be adjusted, so as to adjust the tension on the driving belt to an appropriate value. In addition, due to the rotating connection between the connecting portion and the support, it is possible to make another detection at a next angle of the driving wheel during the detection, so that it is possible to determine whether the values of the tension detected at different angles are qualified. At the same time, the detection position of the tension detecting portion can be adjusted via the sliding adjusting portion, facilitating eliminating the limitation to the detection position suffered in different detection environments, and improving the accuracy of detection by performing a plurality of detections at different positions. When the tension detecting portion is at the same position, the detection data obtained at the same angle of the drive wheel can be compared with a standard data for this state; when the tension detecting portion is at the same position, the values of the tension obtained at different angles of the driving wheel can be compared with each other; and when the driving wheel is at the same angle, the data detected by the tension detecting portion at different positions can be compared with a standard data for different positions of the tension detecting portions, so that a multilevel and high-accuracy detection can be made to the tension of the driving belt, facilitating achieving a high-accuracy adjustment of the tension of the driving belt.

Preferably, the tension detecting portion comprises a connecting rod slidably connected with the support along the length direction of the support, a first compression element and a second compression element provided on the connecting rod for clamping the driving belt, and a pressure sensor connected between the first compression element and the second compression element for converting the value of the tension into an electrical signal.

By adopting the above technical solution, due to the first compression element and the second compression element provided on two ends of the connecting rod for clamping the driving belt and the pressure sensor connected between the first compression element and the second compression element, upon mounting, the driving belt will outwardly apply a compression force onto the first compression element and the second compression element due to its own tension, which is then directly transferred to the pressure sensor for detection, thereby reducing the loss of pressure delivery and improving the detection accuracy.

Preferably, a distance adjusting portion is provided on the connecting rod for adjusting the distance between the second compression element and the first compression element.

By adopting the above technical solution, regarding drive wheels and driving wheels having different sizes on which the driving belt is mounted and as well as the different distance between two sides of the driving belt, the providing of the distance adjusting portion makes it possible to adjust the distance between the first compression element and the second compression element, so as to enable detections at positions having a different distance between the two sides of the driving belts and facilitate a convenient detection.

Preferably, a rotating part is provided on each of the first compression element and the second compression element for converting the sliding friction caused by the driving belt into rotating friction.

By adopting the above technical solution, when it is required to rotate the drive wheel, since the first compression element and the second compression element press against the driving belts, direct sliding will cause great friction and even abrasion to the driving belt; but after the rotating part is provided on both the first compression element and the second compression element, the sliding friction between the first compression element and the second compression element is converted into a rotating friction due to the rotation of the rotating part, thereby effectively reducing the friction force and facilitating an easier rotation of the driving wheel.

Preferably, the connecting portion comprises a connecting shaft for being inserted into the counter bore at the center of the drive wheel, with an inserting shaft being rotatably connected at one end of the connecting shaft departing from the rotary shaft of the drive wheel, inserted in the support and slidably movable along the inserting direction.

By adopting the above technical solution, when mounting and dismantling the detection device, the way of direct insertion facilitates a convenient mounting since one end of the connecting shaft is inserted into the counter bore at the center of the driving wheel; and the inserting shaft will not be caused to rotate together when the drive wheel is rotating since the other end of the connecting shaft is rotatably connected with the inserting shaft. In addition, since the inserting shaft is slidably movable along the inserting direction when being inserted in the support, during the mounting of the detection device, the first compression element and the second compression element can be first mounted onto the two sides of the driving belt, and then the inserting shaft can be inserted into the counter bore at the center of the drive wheel along the inserting direction of the inserting shaft, so that the mounting becomes easy and simple, without the need of any tools or hard efforts; and, vise versa, the dismantling can be performed by reverse steps, easy and simple.

Preferably, the sliding adjusting portion comprises a gear rack connected on the connecting rod and extending along the length direction of the support, a gear engaged with the gear rack, and a power unit for driving the gear to rotate.

By adopting the above technical solution, since the gear rack is connected on the connecting rod and extending along the length direction of the support, when the power unit drives the gear to rotate, the gear rack will drive the connecting rod to slide along the length direction of the support, and such a driving manner between the gear and the gear rack enables a bidirectional adjustment to the sliding positions, thereby supporting the adjustments of a plurality of positions. What's more, after the power unit stops rotation, the position of the connecting rod can be fixed, that is, the detection position of the tension detecting portion can be fixed, facilitating preventing the position displacement during a detection from degrading the detection accuracy.

Regarding the defects present in the prior art, a second object of the present application is to provide a method for detecting and adjusting the tension of a driving belt, facilitating the accuracy for detecting the value of the driving belt tension.

In order to achieve the above object, the present application provides the following technical solutions:

a method for detecting and adjusting the tension of a driving belt by using the above detection device comprises:

step 1) adjusting the tension detecting portion to a first position via the sliding adjusting portion and detecting the value of the tension f1 of the driving belt at the first position;

step 2) comparing the value of the tension f1 with an upper threshold value Fa and a lower threshold value Fb of a standard tension at the first position;

if the value of the tension f1 is between the upper threshold value Fa and the lower threshold value Fb, proceeding to next step,

if the value of the tension f1 is not between the upper threshold value Fa and the lower threshold value Fb, adjusting the distance between the drive wheel and the driven wheel so that the value of the tension f1 falls between the upper threshold value Fa and the lower threshold value Fb, and proceeding to next step;

step 3) rotating the drive wheel by 120° in a fixed direction;

step 4) detecting the tension f1′ of the driving belt for the second time,

if the value of the tension f1′ is still between the upper threshold value Fa and the lower threshold value Fb, proceeding to next step,

if the value of the tension f1′ is not between the upper threshold value Fa and the lower threshold value Fb, adjusting the distance between the drive wheel and the driven wheel so that the value of the tension f1′ falls between the upper threshold value Fa and the lower threshold value Fb, and returning to the step 3) for re-detection;

step 5) rotating the drive wheel by 120° in a fixed direction for the second time;

step 6) detecting the tension f1″ of the driving belt,

if the value of the tension f1″ is still between the upper threshold value Fa and the lower threshold value Fb, determining that the value of the driving belt tension substantially meets the requirement,

if the value of the tension f1″ is not between the upper threshold value Fa and the lower threshold value Fb, adjusting the distance between the drive wheel and the driven wheel so that the value of the tension f1″ falls between the upper threshold value Fa and a lower threshold value Fb, and returning to the step 3) for re-detection.

Generally, a drive wheel is different from a driven wheel in size, and thus the standard values of the driving belt tension when performing a detection at different positions between the drive wheel and the driven wheel are different from each other. However, by adopting the above technical solution, detecting and adjusting are firstly performed at one position so that the tension of the driving belt substantially meets the requirement; the drive wheel is then rotated by an angle and the tension is measured for the second time, and, if the tension of the driving belt meets the requirement, the drive wheel is rotated and the detection is made for another time. If any one of the three measurements does not meet the requirement, the distance between the drive wheel and the driven wheel is adjusted, and the drive wheel is re-rotated and three detections are performed, which can avoid the affect of some rotating angle on the value of the tension, facilitating eliminating the affect of a special angle on the detection and achieving a more accurate detection.

Regarding the defects present in the prior art, a third object of the present application is to provide a method for detecting the error in mounting the rear wheel of a bicycle.

In order to achieve the above object, the present application provide the following technical solutions:

a method for detecting the error in mounting the rear wheel of a bicycle by using the above methods for detecting and adjusting the tension of a driving belt comprises: stopping detection, and determining that the error in mounting the rear wheel of the bicycle does not meet the requirement if the re-detection of returning step 4) back to step 3) successively occurs for three times.

Preferably, the detection is stopped and it is determined that the error in mounting the rear wheel of the bicycle does not meet the requirement if the re-detection of returning step 5) back to step 3) successively occurs for two times.

Preferably, the value of the average tension fa1 of the driving belt at three rotation angles of the drive wheel when the tension detecting portion is at the first position is calculated;

the tension detecting portion is adjusted to a second position, a third position till an nth position via the sliding adjusting portion along the sliding direction, and the values of average tensions fa2, fa3, . . . , fan of the driving belt at individual positions are respectively detected and calculated, where n is equal to or larger than 2;

if the best values of the driving belt tension at individual positions such as the first position, the second position, the third position or the like are Fs1, Fs2, . . . , Fsn, respectively, the errors at individual positions are calculated: F1=\sqrt{(fa1−Fs1)²}, F2=\sqrt{(fa2−Fs2)²}, F3=\sqrt{(fa3−Fs3)²}, . . . , Fn=\sqrt{(fan−Fsn)²}, respectively, and then the value of driving belt tension error is calculated: F=(q1*F1+q2*F2+q3*F3+ . . . +qn*Fn)/n, where q1, q2, q3, . . . , qn are respectively the weighted values of errors corresponding to individual positions where the tension detecting portion is; and

the value F of the driving belt tension error is compared with an allowable value Fs of the driving belt tension error; and, if F is smaller than Fs, it is determined that the error in mounting the rear wheel of the bicycle finally meets the requirement, otherwise it is determined that the error in mounting the rear wheel of the bicycle is not qualified.

In a conventional method for detecting and adjusting the driving belt tension, if a plurality of adjustments are not qualified, the detection and adjustment will be repeated in an endless loop. By adopting the above technical solution, it will be determined that the error in mounting the rear wheel of the bicycle is not qualified if the re-detection of returning step 4) back to step 3) successively occurs for three times or the re-detection of returning step 5) back to step 3) successively occurs for two times. In addition, after the detection is substantially qualified, the tension detecting portion is moved via the sliding adjusting portion to different positions to perform detection, which facilitates finding the affect of positions on the detection and improving the accuracy of detection. As the final result of detection, the final error F is calculated as above, and compared with the value of the allowable value Fs of the driving belt tension error for judging whether the final calculated error F is qualified. This leads to the result that a bicycle which passes the detection has extremely small error, and thus can completely comply with strict requirements for use.

In summary, the present application has the following beneficial effects:

1. the drive wheel can be conveniently rotated by a certain angle for making a plurality of measurements, facilitating reducing the affect of the rotation angle factor of the drive wheel on the detection accuracy; and the detecting positions of the tension detecting portion can be adjusted, facilitating the affect of the detecting position factor and improving the detection accuracy;

2. the present application allows a detection being performed after adjusting to different positions and different angles, so as to achieve a multilevel and high-accuracy detection of the driving belt tension; the detected data can be compared in plural ways, facilitating achieving a high-accuracy adjustment to the driving belt tension; and it can be judged whether the mounting of the rear wheel of a bicycle meets the requirement by a final calculation.

### BRIEF DESCRIPTION OF DRAWINGS

FIG. 1 is a schematic structural diagram of a driving belt tension detection device according to an embodiment of the present application as viewed from the right side thereof

FIG. 2 is a schematic structural diagram of a driving belt tension detection device according to an embodiment of the present application as viewed from the left side thereof.

In the drawings: 1. support; 11. kidney-shaped slot; 2. connecting portion; 21. connecting shaft; 22. elastic element; 23. limiting element; 24. inserting shaft; 3. tension detecting portion; 31. first compression element; 32. connecting rod; 321. slidably movable screw bolt; 322. limiting nut; 33. second compression element; 331. sliding slot; 332. rotating part; 34. pressure sensor; 4. sliding adjusting portion; 41. gear rack; 42. gear; 43. power unit; 5. distance adjusting portion; 51. leading screw; 52. fixing nut.

### DETAILED DESCRIPTION

The present application will be described below in detail in combination with drawings and embodiments.

### Embodiment 1

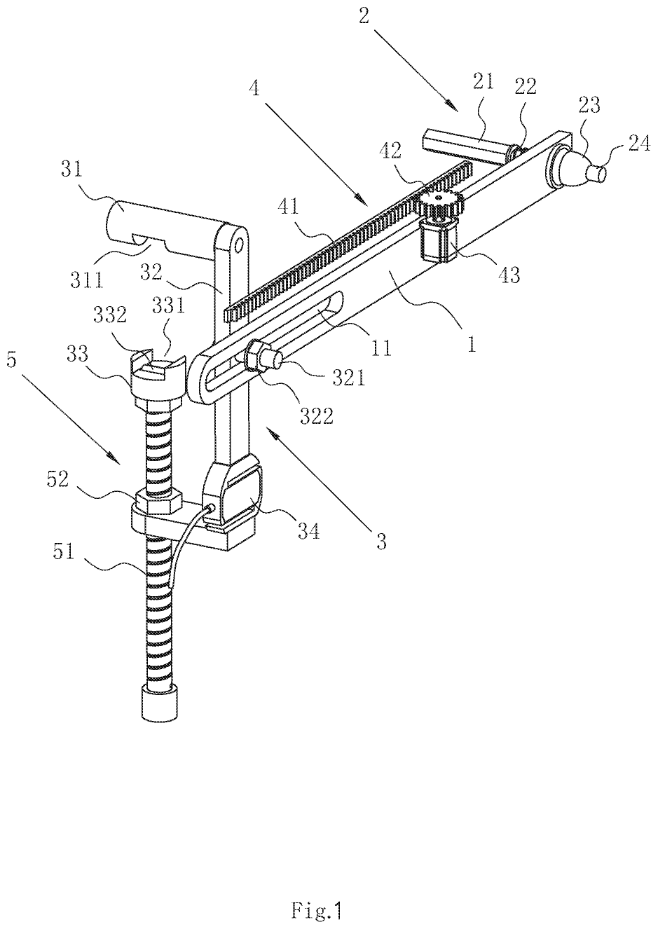

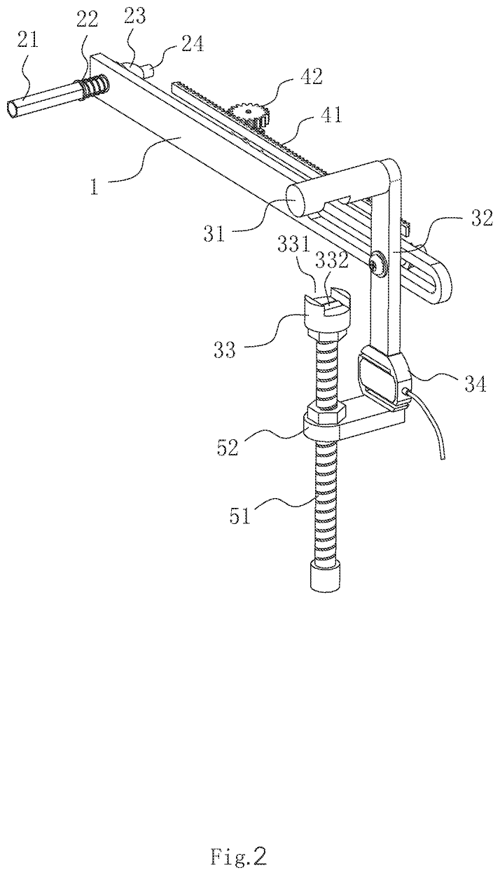

Referring to FIGS. 1 and 2, a driving belt tension detection device comprises a support 1 assuming a strip shape, a connecting portion 2 provided at one end of the support 1 in the length direction and adapted for being mounted on the rotary shaft of a drive wheel, a tension detecting portion 3 provided at the other end of the support 1 and slidably movable along the length direction of the support 1 which clamps the two sides of a driving belt for measuring the amount of the tension on the driving belt, and a sliding adjusting portion 4 provided on the support 1 for adjusting the sliding position of the tension detecting portion 3.

Referring to FIGS. 1 and 2, the tension detecting portion 3 comprises a connecting rod 32 slidably movable along the length direction of the support 1, a first compression element 31 and a second compression element 33 provided on the connecting rod 32, and a pressure sensor 34 connected between the first compression element 31 and the second compression element 33. In particular, a kidney-shaped slot 11 is provided along the length direction of the support 1 at one end of the support 1 departing from a drive wheel, which passes through the support 1. Also, the connecting rod 32 assumes a strip shape, and has a length direction perpendicular to that of the support 1. A slidably movable screw bolt 321 passing through the kidney-shaped slot 11 is provided on the connecting rod 32, the other end of which is connected with a limiting nut 322 for preventing the slidably movable screw bolt 321 from sliding out of the kidney-shaped slot 11.

Referring to FIGS. 1 and 2, the first compression element 31 and the second compression element 33 are provided at two ends of the connecting rod 32 along the length direction thereof, and the pressure sensor 34 is provided in the middle of the connecting rod 32. When the first compression element 31 and the second compression element 33 clamp the upper side and the lower side of the driving belt, a compression force is applied to both the first compression element 31 and the second compression element 33 by the driving belt due to its own tension, which is then passed onto the connecting rod 32 by the first compression element 31 and the second compression element 33, and detected by the pressure sensor 34 provided in the middle of the connecting rod 32 to output an electric signal of detected pressure.

Referring to FIGS. 1 and 2, a distance adjusting portion 5 for adjusting the distance between the first compression element 31 and the second compression element 33 is provided on the connecting rod 32. The distance adjusting portion 5 comprises a leading screw 51 extending from the second compression element 33 to the first compression element 31 and a fixing nut 52 connected on the leading screw 51. The leading screw 51 is rotatably connected on the connecting rod 32, and the fixing nut 52 rotates on the leading screw 51 and presses against one end of the connecting rod 32, so as to fix the leading screw 51 on the connecting rod 32. Moving up or down the position of the leading screw 51 can adjust the distance between the first compression element 31 and the second compression element 33, and thus driving belts having different widths can be put therebetween for detection.

Referring to FIGS. 1 and 2, a sliding slot 311 and a sliding slot 331 disposed opposite to each other and extending along the length direction of the support 1 are respectively provided on the first compression element 31 and the second compression element 33 for receiving one edge of a driving belt, respectively. In addition, in order to reduce the friction between the driving belt and the first compression element 31 and the second compression element 33, a rotating part 332 (the one in the sliding slot 311 is not shown) is provided in each of the sliding slot 311 and the sliding slot 331, which is a rotary roll rotatably connected on the second compression element 33 for pressing against the driving belt.

Referring to FIGS. 1 and 2, the sliding adjusting portion 4 comprises a gear rack 41 perpendicular to the connecting rod 32 and integrally connected on the connecting rod 32, a gear 42 engaged with the gear rack 41, and a power unit 43 for driving the gear 42 to rotate. The gear 41 extends in a direction in parallel with the length direction of the support 1. In one embodiment, the power unit 43 is an electric motor. In other embodiments, the power unit 43 can be a cylinder.

Referring to FIGS. 1 and 2, the connection part 2 comprises an inserting shaft 24 inserted in the support 1 and a connection shaft 21 rotatably connected with the inserting shaft 24. The inserting shaft 24 is on the same side of the support 1 as the tension detecting portion 3. It is inserted in a through hole in the end of the support 1 departing from the first compression element 31 along the length direction of the support 1, and is slidably movable along the direction of the through hole. One end of the inserting shaft 24 departing from the through hole is rotatably connected with the connecting shaft 21, that is, the connecting shaft 21 is sleeved outside the inserting shaft 24 and can rotate concentrically therewith. In addition, an elastic element 22, for example, a spring, is contact connected between the connecting shaft 21 and the support 1. In other embodiments, the elastic element 22 can be a rubber pad, a balloon, or the like. A limiting element 23 for preventing the inserting shaft 24 from falling off the through hole is connected at the end of the inserting shaft 24 departing from the connecting shaft 21. In one embodiment, the limiting element is a liming ring disposed around the inserting shaft 24.

### Embodiment 2

A method for detecting and adjusting the tension of a driving belt by using a detection device comprises:

step 1) adjusting a tension detecting portion to a first position via a sliding adjusting portion and detecting the value of the tension f1 of a driving belt at the first position;

step 2) comparing the value of the tension f1 with an upper threshold value Fa and a lower threshold value Fb of a standard tension at the first position;

if the value of the tension f1 is between the upper threshold value Fa and the lower threshold value Fb, proceeding to next step,

if the value of the tension f1 is not between the upper threshold value Fa and the lower threshold value Fb, adjusting the distance between a drive wheel and a driven wheel so that the value of f1 falls between the upper threshold value Fa and the lower threshold value Fb, and proceeding to next step;

step 3) rotating the drive wheel by 120° in a fixed direction;

step 4) detecting the tension f1′ of the driving belt for the second time,

if the value of the tension f1′ is still between the upper threshold value Fa and the lower threshold value Fb, proceeding to next step,

if the value of the tension f1′ is not between the upper threshold value Fa and the lower threshold value Fb, adjusting the distance between the drive wheel and the driven wheel so that the value of f1′ falls between the upper threshold value Fa and the lower threshold value Fb, and returning to the step 3) for re-detection;

step 5) rotating the drive wheel by 120° in a fixed direction for the second time;

step 6) detecting the tension f1″ of the driving belt,

if the value of the tension f1″ is still between the upper threshold value Fa and the lower threshold value Fb, determining that the value of the tension of the driving belt substantially meets the requirement,

if the value of the tension f1″ is not between the upper threshold value Fa and the lower threshold value Fb, adjusting the distance between the drive wheel and the driven wheel so that the value of f1″ falls between the upper threshold value Fa and a lower threshold value Fb, and returning to the step 3) for re-detection.

### Embodiment 3

Based on a method for detecting and adjusting the tension of a driving belt by using a driving belt detection device, a method for detecting the error in mounting the rear wheel of a bicycle comprises:

stopping detection and determining that the error in mounting the rear wheel of the bicycle does not meet the requirement if the re-detection of returning step 4) back to step 3) successively occurs for three times during the process of detecting and adjusting the tension of a driving belt.

In addition, the detection should be stopped and it should be determined that the error in mounting the rear wheel of the bicycle does not meet the requirement if the re-detection of returning step 5) back to step 3) successively occurs for two times.

Finally, upon the detecting and adjusting of the driving belt tension substantially meets the requirement, the value of the average tension fa1 of the driving belt at three rotation angles of the drive wheel when the tension detecting portion is at the first position is calculated;

the tension detecting portion is adjusted to a second position, a third position till an n^{th} position via the sliding adjusting portion along the sliding direction, and the values of average tensions fa2, fa3, . . . , fan of the driving belt at individual positions are respectively detected and calculated, where n is equal to or larger than 2;

if the best values of the driving belt tension at individual positions such as the first position, the second position, the third position or the like are Fs1, Fs2, . . . , Fsn, respectively, the errors at individual positions are calculated: F1=\sqrt{(fa1−Fs1)²}, F2=\sqrt{(fa2−Fs2)²}, F3=\sqrt{(fa3−Fs3)²}, . . . , Fn=\sqrt{(fan−Fsn)²}, respectively, and then the value of driving belt tension error is calculated: F=(q1*F1+q2*F2+q3*F3+ . . . +qn*Fn)/n, where q₁, q₂, q₃, . . . , qₙ are respectively the weighted values of errors corresponding to individual positions where the tension detecting portion is; and

the value F of the driving belt tension error is compared with an allowable value Fs of the driving belt tension error; and, if F is smaller than Fs, it is determined that the error in mounting the rear wheel of the bicycle finally meets the requirement, otherwise it is determined that the error in mounting the rear wheel of the bicycle is not qualified.

What is provided above is merely the preferred embodiments according to the present application, and the protection scope of the present application is not limited to the above embodiments. On the contrary, all the technical solutions obtained based on the concepts of the present application should fall with in the protection scope of the present application. It should be noted that, for those skilled in the art, some improvements and modifications can be made without departing from the principles of the present applications, which should be also considered as falling within the protection scope of the present application.

What is claimed is:

1. A driving belt tension detection device comprising a support, wherein a connecting portion is rotatably connected at one end of the support in the length direction for being mounted on a drive wheel, a tension detecting portion is slidably provided at the other end of the support along the length direction of the support, which is used for clamping the driving belt for measuring the value of the tension of the driving belt, and a sliding adjusting portion is provided on the support for adjusting the sliding position of the tension detecting portion.

2. The driving belt tension detection device according to claim 1, wherein the tension detecting portion comprises a connecting rod slidably connected with the support along the length direction of the support, a first compression element and a second compression element provided on the connecting rod for clamping the driving belt, and a pressure sensor connected between the first compression element and the second compression element for converting the value of the tension into an electrical signal.

3. The driving belt tension detection device according to claim 2, wherein a distance adjusting portion is provided on the connecting rod for adjusting the distance between the second compression element and the first compression element.

4. The driving belt tension detection device according to claim 3, wherein a rotating part is provided on each of the first compression element and the second compression element for converting the sliding friction caused by the driving belt into rotating friction.

5. The driving belt tension detection device according to claim 1, wherein the connecting portion comprises a connecting shaft for being inserted into a counter bore at the center of the drive wheel, with an inserting shaft being rotatably connected at one end of the connecting shaft departing from the rotary shaft of the drive wheel, inserted in the support and slidably movable along the inserting direction.

6. The driving belt tension detection device according to claim 2, wherein the sliding adjusting portion comprises a gear rack connected on the connecting rod and extending along the length direction of the support, a gear engaged with the gear rack, and a power unit for driving the gear to rotate.

7. A method for detecting and adjusting the tension of a driving belt by using the detection device according to claim 1 comprising:
step 1) adjusting the tension detecting portion to a first position via the sliding adjusting portion and detecting the value of the tension f1 of the driving belt at the first position;
step 2) comparing the value of the tension f1 with an upper threshold value Fa and a lower threshold value Fb of a standard tension at the first position;
if the value of the tension f1 is between the upper threshold value Fa and the lower threshold value Fb, proceeding to next step,
if the value of the tension f1 is not between the upper threshold value Fa and the lower threshold value Fb, adjusting the distance between the drive wheel and the driven wheel so that the value of the tension f1 falls between the upper threshold value Fa and the lower threshold value Fb, and proceeding to next step;
step 3) rotating the drive wheel by 120° in a fixed direction;
step 4) detecting the tension f1′ of the driving belt for the second time,
if the value of the tension f1′ is still between the upper threshold value Fa and the lower threshold value Fb, proceeding to next step,
if the value of the tension f1′ is not between the upper threshold value Fa and the lower threshold value Fb, adjusting the distance between the drive wheel and the driven wheel so that the value of the tension f1′ falls between the upper threshold value Fa and the lower threshold value Fb, and returning to the step 3) for re-detection;
step 5) rotating the drive wheel by 120° in a fixed direction for the second time;
step 6) detecting the tension f1″ of the driving belt,
if the value of the tension f1″ is still between the upper threshold value Fa and the lower threshold value Fb, determining that the value of the driving belt tension substantially meets the requirement,
if the value of the tension f1″ is not between the upper threshold value Fa and the lower threshold value Fb, adjusting the distance between the drive wheel and the driven wheel so that the value of the tension f1″ falls between the upper threshold value Fa and a lower threshold value Fb, and returning to the step 3) for re-detection.

8. A method for detecting the error in mounting the rear wheel of a bicycle by using the method for detecting and adjusting the tension of a driving belt according to claim 7 comprising: stopping detection, and determining that the error in mounting the rear wheel of the bicycle does not meet the requirement if the re-detection of returning step 4) back to step 3) successively occurs for three times.

9. The method for detecting the error in mounting the rear wheel of a bicycle according to claim 8, wherein the detection is stopped and it is determined that the error in mounting the rear wheel of the bicycle does not meet the requirement if the re-detection of returning step 5) back to step 3) successively occurs for two times.

10. The method for detecting the error in mounting the rear wheel of a bicycle according to claim 9, wherein the value of the average tension fa1 of the driving belt at three rotation angles of the drive wheel when the tension detecting portion is at the first position is calculated;
the tension detecting portion is adjusted to a second position, a third position till an nth position via the sliding adjusting portion along the sliding direction, and the values of average tensions fa2, fa3, . . . , fan of the driving belt at individual positions are respectively detected and calculated, where n is equal to or larger than 2;
if the best values of the driving belt tension at individual positions such as the first position, the second position, the third position or the like are Fs1, Fs2, . . . , Fsn, respectively, the errors at individual positions are calculated: F1=\sqrt{(fa1−Fs1)²}, F2=\sqrt{(fa2−Fs2)²}, F3=\sqrt{(fa3−Fs3)²}, . . . , Fn=\sqrt{(fan−Fsn)²}, respectively, and the value of the driving belt tension error is calculated: F=(q1*F1+q2*F2+q3*F3+ . . . +qn*Fn)/n, where q1, q2, q3, . . . , qn are respectively the weighted values of errors corresponding to individual positions where the tension detecting portion is; and
the value F of the driving belt tension error is compared with an allowable value Fs of the driving belt tension error; and, if F is smaller than Fs, it is determined that the error in mounting the rear wheel of the bicycle meets the final requirement, otherwise it is determined that the error in mounting the rear wheel of the bicycle is not qualified.
